(19) United States
(12) Patent Application Publication
(10) Pub. No.: US 2025/0356525 A1
(43) Pub. Date: Nov. 20, 2025

(54) AIRCRAFT VISION SYSTEM WITH AN INCONSISTENCY DETECTION SYSTEM AND CORRESPONDING METHOD

(71) Applicant: DASSAULT AVIATION, Paris (FR)

(72) Inventors: Clément MATHIEU, Merignac (FR); Olivier Baudson, Saint-Cloud Cedex (FR)

(21) Appl. No.: 19/206,040

(22) Filed: May 13, 2025

(30) Foreign Application Priority Data
May 14, 2024 (FR) 24 04908

(51) Int. Cl. G06T 7/73; B64D 43/00; G08G 5/54; H04N 7/18

(52) U.S. Cl. CPC G06T 7/74; B64D 43/00; G08G 5/54; H04N 7/183; G06T 2207/10024; G06T 2207/10032; G06T 2207/30242; G06T 2207/30252

(57) ABSTRACT

An improved aircraft vision system includes a display, a system for detecting inconsistencies between a displayed position of a synthetic depiction and the actual position on the display of a runway and/or of an approach lighting system. The inconsistency detection system includes a module for identifying a row of lights extending transversely to the runway, a system for characterising the at least one row of lights identified in order to determine a given position of the at least one row of lights relative to the runway from among a plurality of possible positions extending transversely to the runway and a calculation module configured to calculate an actual position on the display of the runway and/or approach lighting system using the determined position of the at least one row of lights.

### TECHNICAL FIELD

The present disclosure relates to an aircraft enhanced vision system, comprising:
a display, for viewing the space in front of the aircraft and a display generator on the display, configured to display on the display a synthetic depiction of the positioning of a landing runway and/or of an approach lighting system towards the runway at a displayed position of the runway and/or of the approach lighting system;
a system for detecting inconsistencies between the displayed position from the synthetic depiction and the actual viewing position on the display of the runway and/or of the approach lighting system.

Such a system is designed to be installed in the cockpit of an aircraft to be associated with a cockpit display. The display is, for example, an at least partially transparent display, such as a semi-transparent screen placed in front of a cockpit windscreen, a system for projecting images onto the cockpit windscreen, a semi-transparent sun visor, a helmet visor, or a semi-transparent bezel close to the eye. Alternatively, the display can be used as a head-down display integrated into the cockpit instrument panel.

For example, the cockpit is inside the aircraft, as in the case of a business jet or airliner or is a control room located remotely from the aircraft, as in the case of a drone.

### BACKGROUND

The display system is designed to make it easier to pilot the aircraft when landing in low or zero visibility conditions.

In such conditions, guidance systems allow the pilot to approach the runway as close as possible. However, landing is only possible when the pilot can actually see the runway.

In all cases, at the end of the approach, the pilot tries to visually locate the position of the runway, in order to make the decision to land or, on the contrary, to carry out a go-around.

To make it easier to pilot the aircraft, and to give the pilot an overall indication of the structure of the terrain facing the aircraft, it is known to generate synthetic images of the landscape located in front of the aircraft, in particular from topographic databases, as a function of the current position of the aircraft determined by the aircraft's navigation system.

The synthetic images are representative of the environment in front of the aircraft, as seen through the windscreen by a pilot in the cockpit.

In some cases, these synthetic images include a synthetic marking of the runway at the position where it is supposed to be.

This kind of vision system allows the pilot to tell where the runway is located.

Such vision systems provide substantial assistance to the pilot, but are sometimes imprecise, given possible errors in the positioning of the aircraft and/or in the topographical data available in the databases.

It is therefore necessary to have a real vision of the environment outside the aircraft at the same time.

To make it easier to find the runway threshold in low-visibility conditions, most aerodromes are equipped with approach lighting systems located longitudinally in front of the runway threshold.

These light systems generally comprise at least one longitudinal row of lights aligned along the runway axis, and perpendicular to the longitudinal line, at least one transverse row of lights crossing the longitudinal line.

To make it easier to find the approach lighting system, Enhanced Vision Systems (EVS) have been developed.

These systems generally comprise an on-board camera in the nose of the aircraft. The camera, which for example comprises sensors operating in a plurality of wavelength bands, improves visibility in front of the aircraft, by detecting the terrain and any structures present on the ground, such as lights on or around the runway, in particular approach lighting systems.

Based on the images collected by the camera, a real image of the environment in front of the aircraft is obtained.

Such vision systems can therefore confirm the position of the runway in relation to the aircraft and/or the environment, and make it easier for the pilot to make a decision at the decision altitude, at which he must decide whether or not to continue with the landing.

In certain cases where visibility is very low, and below the value required to carry out the approach without a vision system, an enhanced vision system can be used below the decision height, to help secure the trajectory to the runway.

In this case, the pilot must ensure, before using the synthetic marking representing the runway on the display of the enhanced vision system, that the position of the marking on the display is reliable and corresponds to the actual position where the runway will appear.

A consistency test must therefore be carried out by the pilot. This consistency test ensures that the trajectory followed by the aircraft between decision height and touchdown is correct.

In this respect, the pilot should try in particular to locate the actual position of the approach lighting system in the image produced by the display to ensure that their position is consistent with the synthetic runway marking. Alternatively, he or she must compare the actual position of the runway threshold lights in the image he or she observes on the display, to the synthetic runway threshold marking indicated by the enhanced vision system. This task is an essential part of the landing decision, which must be made very quickly, in a matter of seconds. It relies solely on the pilot's visual judgement.

In some cases, a fault may occur in an aircraft positioning system, leading to a discrepancy between the position of the synthetic runway marking on the screen obtained from the positioning system, and the actual position of the runway. There is then a risk that the pilot will land the aircraft before the runway threshold, if the indications given by the position sensor are not accurate.

### SUMMARY

One aim of the present disclosure is therefore to improve the reliability of an enhanced vision system, in order to allow approaches in very low visibility conditions, in particular visibility conditions lower than those required to make the approach without an enhanced vision system, in particular between decision height and the ground.

To this end, the present disclosure relates to a system of the aforementioned type, characterised in that the inconsistency detection system comprises:
a first module for identifying, in an optical image of the space in front of the aircraft, at least one row of lights extending transversely to an axis of the runway;
a system for characterising the row of lights identified from the first identification module, the characterisation system being configured to determine a determined position of the row of lights relative to the runway from among a plurality of possible positions of rows of lights extending transversely to an axis of the runway;
a calculation module configured to calculate an actual position on the display of the runway and/or approach lighting system using the determined position of the row of lights.

The system according to the present disclosure may comprise one or more of the following features, taken alone or in any combination that is technically possible:
the determined position of the row of lights is a specific geographical position of the row of lights;
the system comprises a signature base containing known reference signatures corresponding to transverse rows of lights found on various types of known approach lighting systems;
each signature or combination of reference signatures in the signature database being associated with a runway threshold distance or with a limited number of possible runway threshold distances;
the display generation assembly is connected to a sensor system for measuring aircraft parameters and spatial positioning of the aircraft;
the display generator is configured to display the synthetic depiction of the positioning of the runway and/or the approach lighting system at the position displayed on the display, as a function of the position of the aircraft determined by a position sensor of the aircraft, in particular by a GPS sensor or/and by an inertial unit;
the display generator is configured to display, on the display, the optical image of the space located in front of the aircraft, and to display, superimposed, the synthetic depiction of the positioning of the runway and/or the approach lighting system for approaching the runway;
the system for characterising the row of lights comprises a light counting module, on the row of lights to define at least one signature of the row of lights; and a module for comparing the or each signature of the row of lights with known signatures of rows of lights in a database of known signatures of rows of lights, to identify at least one known signature corresponding to the or each signature defined by the light counting module, the system for characterising the row of lights being configured to determine the determined position of the row of lights using the or each known signature identified by the comparison module;
the light counting module is configured to define at least one transverse signature of the row of lights;
the inconsistency detection system comprises a second module for identifying, in the optical image, an alignment of lights extending along the axis of the runway, the light counting module being configured to count, on the row of lights, the number of lights on either side of the alignment and, in the alignment, to define at least one signature of the row of lights;
the transverse signature comprises a number of lights on the alignment at the row of lights, and numbers of lights detected on either side of the alignment on the row of lights;
the light counting module is configured to define at least one axial signature of the row of lights;
the axial signature comprises the number of lights on the alignment at the row of lights and at least one number of lights on at least one row of lights axially adjacent to the row of lights;
the calculation module is configured to calculate a roll angle of the aircraft, on the basis of a detected axial orientation of the alignment detected by the module for identifying an alignment of lights extending along the axis of the runway;
the first identification module is configured to identify a color and/or a periodic lighting intermittence of at least one light in the row of lights, the signature of the row of lights comprising at least the color and/or a lighting intermittence feature of at least one light in the row of lights;
the row of lights is a transverse row of approach lighting system for approaching the runway, the database being a database of signatures of transverse rows of approach lighting systems for approaching a runway;
the row of lights is a runway threshold bar, the database being a database of runway threshold bar signatures;
the comparison module is configured to determine from the signature of the row of lights whether the row of lights is a transverse row of approach lighting system for approaching the runway or whether the row of lights is a runway threshold bar, possibly offset;
the system for characterising the row of lights identified from the first identification module comprises an artificial intelligence engine configured to determine the determined position of the row of lights with respect to the runway from among the plurality of possible positions of rows of lights extending transversely to an axis of the runway from an analysis of a region of the optical image comprising the row of lights;
the calculation module is configured to determine an actual distance between the row of lights and at least one light adjacent to the row of lights using the distance on the optical image between the row of lights and the adjacent light, and a measured height of the aircraft relative to the ground;
the calculation module is configured to assume a predetermined actual distance gap between the light adjacent to the row of lights and the row of lights, and then is configured to calculate an assumed height of the aircraft relative to the ground using the assumed distance between the lights, and to compare the assumed height of the aircraft relative to the ground with the measured height of the aircraft relative to the ground;
the inconsistency detection system comprises an inconsistency warning module, configured to generate a warning signal when the difference between the position displayed on the synthetic depiction display and the actual viewing position on the display of the runway and/or the approach lighting system calculated by the calculation module is greater than a given threshold.

The present disclosure also relates to an enhanced vision method implemented in an aircraft equipped with an enhanced vision system as defined above, the method comprising the following steps:
display on the display by the display generator of a synthetic depiction of the positioning of a runway and/or of an approach lighting system towards the runway at a displayed position of the runway and/or of the approach lighting system;
detection, by the system for detecting inconsistencies, of an inconsistency between the displayed position from the synthetic depiction and the actual viewing position on the display of the runway and/or of the approach lighting system;

characterised in that the detection by the inconsistency detection system comprises the following steps:
identification, by a first identification module, in an optical image of the space in front of the aircraft, at least one row of lights extending transversely to an axis of the runway;
characterisation, by the system for characterising the row of lights identified from the first identification module, to determine a determined position of the row of lights relative to the runway from among a plurality of possible positions of rows of lights extending transversely to an axis of the runway;
determination, by the calculation module, of an actual position on the display of the runway and/or approach lighting system using the determined position of the row of lights.

The method according to the present disclosure may include one or more of the following features, taken alone or in any combination that is technically possible:
the characterisation of the row of lights identified from the first identification module comprises counting lights on the row of lights, by a light counting module of the characterisation system, to define at least one signature of the row of lights and comparing, by the comparison module, the or each signature of the row of lights with known signatures of rows of lights in a database of known signatures of rows of lights, to identify at least one known signature corresponding to the or each signature defined by the light counting module; the method comprising determining, by the characterisation system, a determined position of the row of lights using the or each known signature identified by the comparison module.

### BRIEF SUMMARY OF THE DRAWINGS

The present disclosure will be better understood upon reading the following description, given only as an example, and with reference to the attached drawings, in which:

FIG. 1 is a block diagram illustrating the vision system according to the present disclosure;

FIG. 2 is a schematic view of the displays in the cockpit of an aircraft equipped with the vision system according to the present disclosure;

FIG. 3 is a simplified view of the vision offered to the pilot through a display of the enhanced vision system according to the present disclosure, in the case that the synthetic marking of the runway positioning is positioned consistently;

FIG. 4 is a top view of the light distribution patterns in a “CALVERT” type approach lighting system, suitable for being approached by a vision system according to the present disclosure;

FIG. 5 is a view of an image obtained using the enhanced vision system according to the present disclosure, in which a first detection of a longitudinal axis and a transverse row of an approach lighting system is carried out;

FIG. 6 is a view similar to FIG. 5, illustrating the operations of counting the lights on a transverse row of the lighting system to determine a transverse signature of the lighting system;

FIG. 7 is an analogous view to FIG. 6, to determine an axial signature of the transverse row of lights;

FIG. 8 illustrates the principle of the calculation used to determine the distance separating two successive rows of lights on the lighting system, from the distance separating two successive rows of lights on an image obtained by the vision sensor according to the present disclosure;

FIG. 9 is a view similar to FIG. 5, in which the distances to the runway threshold have been marked;

FIG. 10 is a view similar to FIG. 5, illustrating the determination of a transverse signature of a runway threshold bar;

FIG. 11 is a view analogous to FIG. 3, in the case of an inconsistency between the actual position of the runway and the runway location marking on the display, detected by the vision system according to the present disclosure; and

FIG. 12 is a block diagram summarising the main stages of an enhanced vision method according to the present disclosure.

### DETAILED DESCRIPTION

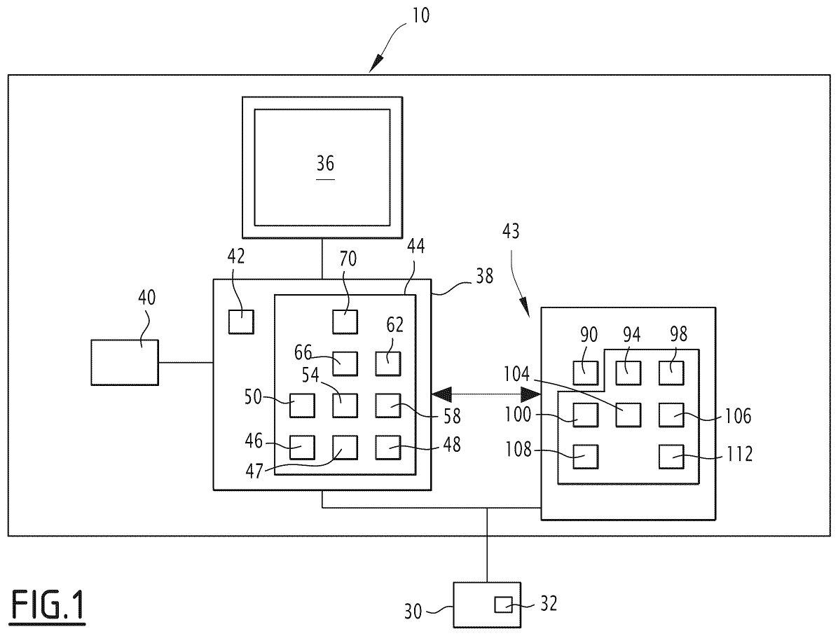

A first enhanced vision system 10 according to the present disclosure is illustrated schematically in FIG. 1.

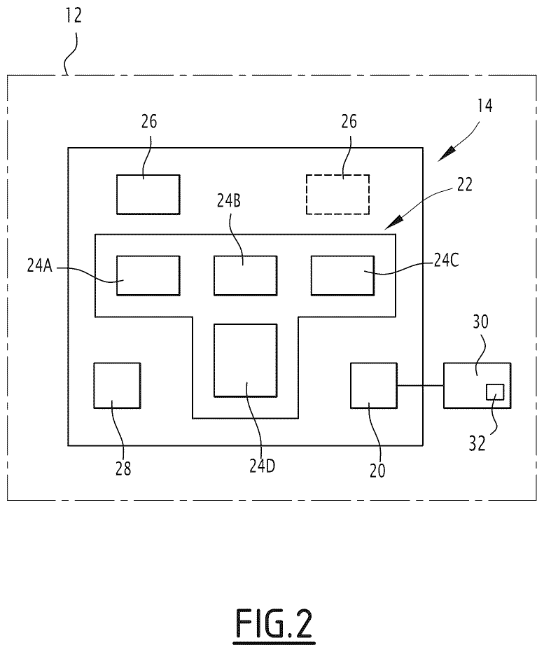

This vision system 10 is intended to be installed in an aircraft 12, shown schematically in FIG. 2, to enable information to be displayed on a display in the cockpit 14 of the aircraft 12.

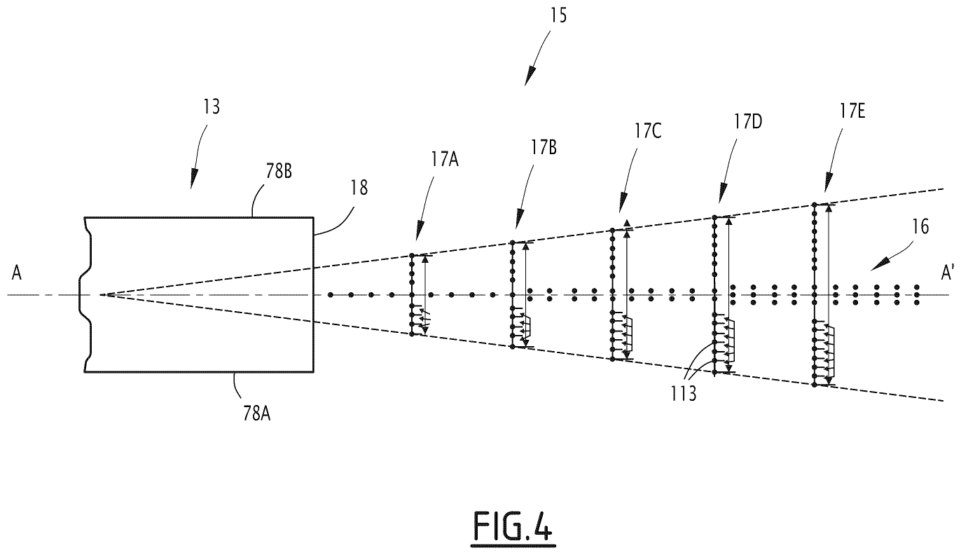

The vision system 10 is designed to assist the pilot of the aircraft 12 during an approach phase, in the vicinity of a runway 13, shown schematically in FIG. 4.

In particular, the vision system 10 is designed to assist the pilot in visually locating the runway 13 from the cockpit 14 in order to make the decision whether or not to land the aircraft 12 on the runway 13, by detecting the light position of an approach lighting system 15 for approaching the runway 13.

Generally speaking, with reference to FIG. 4, the approach lighting system 15 extends in front of the runway 13, along its A-A′ axis.

It comprises at least one axial alignment 16 of lights forming the runway axis A-A′, and at least one transverse row 17A to 17E of lights, perpendicular to the axial alignment 16, crossing the axial alignment 16 and extending on either side of the axial alignment 16.

Generally, the axial alignment 16 extends from the runway threshold 18 for an axial distance, taken from the runway threshold 18, greater than 420 m (1400 ft), and generally between 420 m and 900 m (3500 ft).

The transverse rows 17A to 17E are spaced apart longitudinally. Preferably, at least one transverse row 17B extends transversely at a distance of between 274 m (900 ft) and 335 m (1100 ft) from the runway threshold 18, preferably at 300 m (1000 ft) from the runway threshold 18.

In the example shown in FIG. 4, the width of the axial alignment 16, resulting from the number of lights in it, decreases as it approaches the runway threshold 18.

The transverse rows 17A to 17E are spaced apart longitudinally, typically by at least 150 m (500 ft). In the example shown in FIG. 4, the width of the transverse rows 17A to 17E decreases when approaching the runway threshold 18. The width of the row 17B is, for example, between 10 m (33 feet) and 60 m (197 feet), for example 30 m or 60 m.

In a variant of the approach lighting system 15, not shown, the lighting system 15 comprises a transverse row located at the level of the runway threshold 18, and two longitudinal lines parallel to the axial alignment, connecting the free ends of the transverse rows together, to the left and right of the axial alignment.

In another variant, not shown, the lighting system 15 has an axial alignment that widens as it approaches the runway threshold 18. It comprises a transverse row located at the runway threshold 18, and a single transverse row extending transversely at a distance of between 274 m (900 feet) and 335 m (1100 feet) from the runway threshold 18, preferably at 300 m (1000 feet) from the runway threshold 18. It does not include any other transverse rows.

More generally, the approach lighting system 15 is of a standardised type, for example CALVERT CAT I or CAT II, T-Bar, ALSF CAT I or CAT II, MALSR, MALSF, SSALF, or SSALR. Each of these types of approach lighting systems 15 comprises light configurations feature of the type of approach lighting system 15, independently of the terrain on which the approach lighting system 15 is installed.

With reference to FIG. 2, the cockpit 14 is equipped with a main display system 22 connected to a central avionics unit 20.

The main system 22 enables the crew to pilot the aircraft 12, manage its navigation and monitor and control the various functional systems present in the aircraft 12. The system 22 comprises a dashboard equipped with one or a plurality of base screens 24A to 24D forming head-down displays.

In this example, the cockpit 14 is also advantageously equipped with at least one semi-transparent head-up display 26, positioned opposite the windscreen, or even two semi-transparent head-up displays 26.

The cockpit 14 is also equipped with an aircraft control unit 28, such as a joystick or lever.

In a known way, the base screen(s) 24A and 24C are, for example, primary display screens intended for displaying aircraft flight parameters. The base screens 24B and 24D are, for example, multifunctional screens for navigation and/or monitoring and controlling avionics systems.

The main display system 22 is provided with a display generation assembly (not shown) configured to display the various windows present on these screens 24A to 24D.

The central avionics unit 20 is connected to a sensor system 30 for measuring aircraft parameters and spatial positioning of the aircraft 12.

The measurement sensor system 30 comprises, for example, sensors for measuring parameters external to the aircraft, such as temperature, pressure or speed, sensors for measuring parameters internal to the aircraft and to its various functional systems, and positioning sensors, such as geographical position sensors, in particular a GPS sensor, sensors for determining the pitch of the aircraft, in particular at least one inertial measurement unit, and a sensor for determining a height relative to the ground, in particular a radio altimeter.

The sensors of the measurement sensor system 30 are able to provide information on the geographical position of the aircraft 12, its speed, heading and attitude (pitch, roll angle).

In addition, the sensor system 30 comprises at least one electro-optical/infrared sensor 32, for example located in the nose of the aircraft 12, as described in European patent EP 2 716 548.

The electro-optical/infrared sensor 32 advantageously comprises a plurality of optical detectors, arranged for example side by side, the wavelength bands for which each detector is sensitive being able to vary from one detector to another.

“Optical detector” means a detector capable of operating at wavelengths generally between 0.3 μm and 15.0 μm to form images which will be referred to as “optical images”.

Thus, the electro-optical/infrared sensor 32 is configured to generate an optical image of the space located in front of and below the aircraft, from the data received from the detector(s) of the electro-optical/infrared sensor 32, preferably by merging the data obtained from each detector of the sensor 32 within the same image.

The or each detector on the electro-optical/infrared sensor 32 is a passive detector. The electro-optical/infrared sensor 32 is incapable of generating a signal to be sent into the space opposite and below the aircraft 12, unlike a radar.

With reference to FIG. 1, the enhanced vision system 10 according to the present disclosure is connected to the measurement and positioning system 30.

The vision system 10 comprises at least one display 36, and a display generator 38 on the display 36, connected to the display 36 and to the measurement sensor system 30. The vision system 10 further comprises a human/machine interface 40.

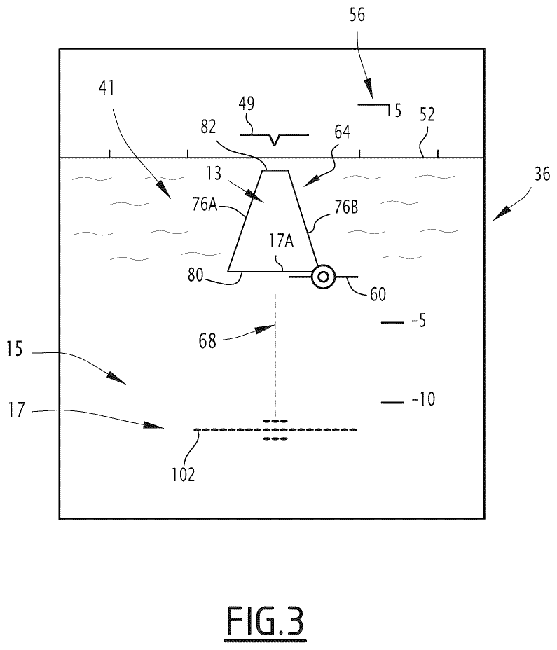

With reference to FIG. 3, the display generator 38 is configured to display on the display 36 a synthetic depiction 41 of the position of a runway 13 and/or of the approach lighting system 15 to the runway 13, at a position displayed on the display 36. This displayed position of the synthetic depiction 41 corresponds, in the absence of a malfunction, to the actual viewing position of the runway 13 and/or the approach lighting system 15 on the display 36.

Thus, in the event that the runway 13 and/or the approach lighting system 15 are masked, for example by a cloud layer, and are therefore invisible on the display 36, the synthetic depiction 41 is positioned at the position on the display 36 where the runway 13 and/or the approach lighting system 15 would be visible in the space in front of the aircraft 12, in the absence of a cloud layer.

According to the present disclosure, the vision system 10 further comprises a system 43 for detecting inconsistencies between the displayed position of the synthetic depiction 41 and the actual viewing position of the runway 13 and/or the approach lighting system 15 on the display 36.

The display 36 is, for example, one of the screens 24A to 24B and/or is the semi-transparent head-up display 26 in the cockpit 14. In other variants, the display 36 is, for example, a system for projecting images onto the cockpit windscreen, a semi-transparent sun visor, a helmet visor, or a semi-transparent bezel close to the eye.

The display 36 enables the pilot to observe the space in front of the aircraft 12, for example by transparency or by displaying an optical image of this space and, simultaneously, a display generated by the display generation assembly 38.

In a first embodiment, which will be described later, the display 36 of the vision system 10 according to the present disclosure is the semi-transparent head-up display 26 of the cockpit 14.

The display generation assembly 38 comprises at least one processor 42 and at least one memory 44 containing a plurality of software modules suitable for execution by the processor 42. It comprises a database 46 of runway features, for example stored in memory 44. Alternatively, it comprises field-programmable gate arrays (FPGAs) or dedicated integrated circuits designed to perform the functions of the modules described below.

The display generation assembly 38 comprises a module 48 for retrieving data from the measurement sensors of the system 30, in particular the geographical position of the aircraft 12 relative to the ground.

With reference to FIGS. 1 and 3, the display generation assembly 38 comprises a module 47 for generating an aircraft model symbol 49, a module 50 for generating an artificial horizon line 52, and an associated module 54 for generating a pitch scale 56.

The display generation assembly 38 further comprises a module 58 for generating a speed vector symbol 60 and modules (not shown) for generating other symbols representing flight parameters, for example an altitude indicator, airspeed indicators, vertical speed indicators, engine information groundspeed indicators, and lift-conformance indicators for the aircraft.

The display generation assembly 38 further comprises a module 62 for generating a marking 64 for locating the runway 13, and a module 66 for generating a runway axis symbol 68, the marking 64 and the symbol 68 being suitable for being displayed on approach to the runway 13, advantageously once the runway 13 has been selected by the pilot.

The generation module 47 is configured to generate the display of an aircraft model symbol 49 which represents a projection to infinity of the longitudinal axis of the aircraft 12, from data received from the sensors of the positioning system 30.

The generation module 50 is configured to determine, from data received from the sensors of the positioning system 30, the position of an artificial horizon line 52 relative to the current attitude of the aircraft. This horizon line 52 is straight when the aircraft 12 is flying with wings flat, and inclines as a function of the bank angle of the aircraft 12.

The module 58 is configured to generate the display of a speed vector symbol 60 indicating the direction of the speed vector of the aircraft 12, on the basis of the data received from the sensors of the measurement system 30. The vertical distance between the artificial horizon line 52 and the speed vector symbol 60 represents the ground pitch of the aircraft 12.

The generation module 54 is configured to display a pitch scale 56 located on either side of the speed vector symbol 60 and represented by graduations illustrating successive degrees of pitch.

The generation module 62 is configured so as to generate at least one runway location marking 64 materializing the geographical position of the runway 13, during a landing approach phase, when the runway 13 is likely to be visible in front of the aircraft 12.

This can be displayed when the pilot has selected the target runway. It is displayed, for example, when the aircraft 12 is at a height of less than 365 m (1200 feet) and at a distance of less than 9.3 km (5 nautical miles) from the threshold 18 of the runway 13.

The runway location marking 64 comprises at least two left and right lateral location symbols 76A, 76B for the position of the runway 13, the position of which is determined from the geographical coordinates of the runway 13 contained in the database 46 and the geographical position of the aircraft 12 relative to the ground obtained from the measurement sensors of the system 30.

These symbols 76A, 76B are for example two converging lines positioned locally on the display 36, to correspond to geographical lines 78A, 78B parallel to the axis of the runway 13 on the ground (see FIG. 4), located along the edges of the runway 13 or at a predefined distance therefrom, as obtained from the database 46.

The length of the geographical lines 78A, 78B, and consequently the length on the display 36 of the symbols 76A, 76B corresponds to the geographical length of the runway 13, as obtained from the database 46.

Potentially, the runway location marking 64 further comprises a runway threshold location symbol 80 and an end of runway location symbol 82, formed respectively by lines connecting the longitudinal ends of symbols 76A, 76B.

The generation module 66 is configured to display a symbol 68 illustrating the direction on the display 36 of the runway axis A-A′, for example a dotted line, below and away from the position corresponding to the runway threshold 18 on the display 36.

With reference to FIG. 1, the inconsistency detection system 43 comprises a processor 90 and a memory 92 containing software modules for execution by the processor. Alternatively, it comprises programmable logic components or dedicated integrated circuits to perform the functions of the modules described below.

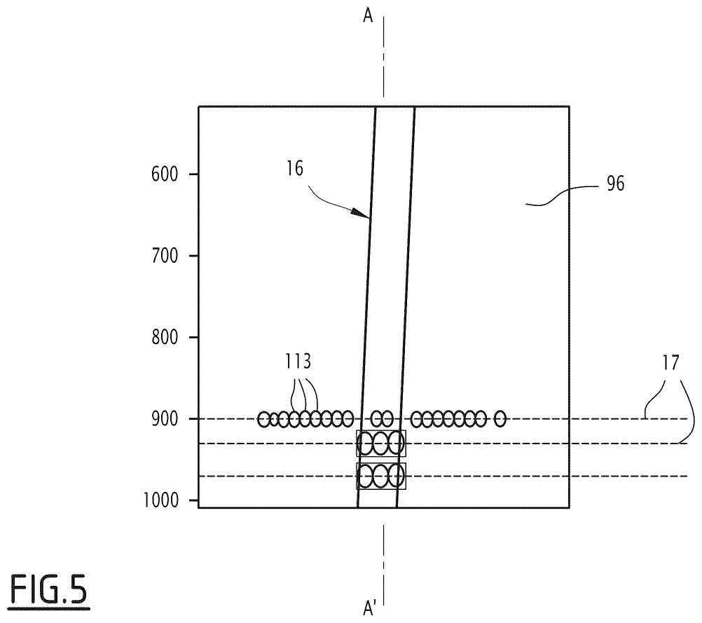

The inconsistency detection system 43 comprises a module 94 for identifying, in an optical image 96 of the space located in front of the aircraft 12 (visible in particular in FIG. 5), obtained by the electro-optical/infrared sensor 32, at least one row of lights 17 extending transversely to an axis A-A′ of the runway 13.

It further comprises a module 98 for identifying, in the optical image 96, an axial alignment 16 of lights extending along the axis A-A′ of the runway 13.

The inconsistency detection system 43 comprises a system for characterising the row of lights 17 identified from the first identification module 94 and/or from the axial alignment 16, configured to determine a determined position of the row of lights 17 relative to the runway 13 from among a plurality of possible positions of rows of lights extending transversely to an axis A-A′ of the runway 13. This position is advantageously determined without having to identify all the rows of lights at all the positions among the plurality of possible positions, nor without necessarily having a complete image of the approach lighting system 15.

In this example, the characterisation system comprises a module 100 for counting lights 113, on the transverse row of lights 17, on either side of the alignment 16, and in the alignment 16 to define at least one signature ST, SA of the transverse row of lights 17.

The characterisation system further comprises a base 104 of known reference signatures STR, SAR and a module 106 for comparing the signature ST, SA of the row of lights 17 defined by the counting module 100 with known signatures in the signature base 104, in order to identify a known signature STR, SAR corresponding to the or each signature ST, SA.

As seen below, the STR and SAR reference signatures are advantageously characteristic of a local light configuration on one type of approach lighting system, and are totally independent of the type of airport on which the approach lighting system are installed.

The characterisation system further comprises a calculation module 108 configured to calculate the geographical position of the row of lights 17 relative to the runway 13 using the known signature STR, SAR.

The inconsistency detection system 43 comprises a calculation module (which may advantageously be the calculation module 108) configured to calculate the actual position of the runway 13 and/or the approach lighting system 15 on the display 36 using the position of the row of lights 17 calculated using the known signature identified STR, SAR.

Finally, the inconsistency detection system 43 comprises a detected inconsistency warning module 112, configured to generate a warning signal when the difference in position on the display 36 between the displayed position of the synthetic depiction 41 and the actual position on the display 36 of the runway 13 and/or of the approach lighting system 15 calculated by the calculation module 108 is greater than a given threshold.

The identification module 94 is suitable, with reference to FIG. 5, for receiving, at each instant, an optical image 96 of the space situated in front of the aircraft obtained by the electro-optical/infrared sensor 32, then for processing this optical image 96 to obtain, in the optical image 96, a detection of the approach lights 113 observed in the approach lighting system 15, or in a threshold bar of the runway 13.

The approach lights 113 are detected, for example, by estimating the noise and contrast locally, and by comparing the contrast with the noise and/or by thresholding an absolute level.

The approach lights 113 are identified as in the image in the form of roughly circular symbols.

The identification module 94 is then configured to determine which of the approach lights 113 detected in the optical image 96 constitute transverse rows 17 of lights of an approach lighting system 15.

Similarly, the identification module 98 is configured to determine, from among the approach lights 113 detected in the optical image 96, axial alignments 16 extending along the axis A-A′ of the runway 13, or parallel thereto.

This identification is made regardless of the number of lights 113 present on each row 17 or on each alignment 16, and even if some lights 113 are switched off or are not detected.

The detection of rows 17 and alignments 16 may take account of the roll of the aircraft 12, even if this is not determined, by searching, on the optical image 96, for horizontal or substantially horizontal rows, with a given angular difference with respect to the horizontal, or vertical or substantially vertical rows, with a given angular difference with respect to the vertical. The angular difference given generally corresponds to the maximum roll of the aircraft, for example 10° for horizontal rows and advantageously up to 60° for vertical rows, particularly for approaches at an angle to the runway.

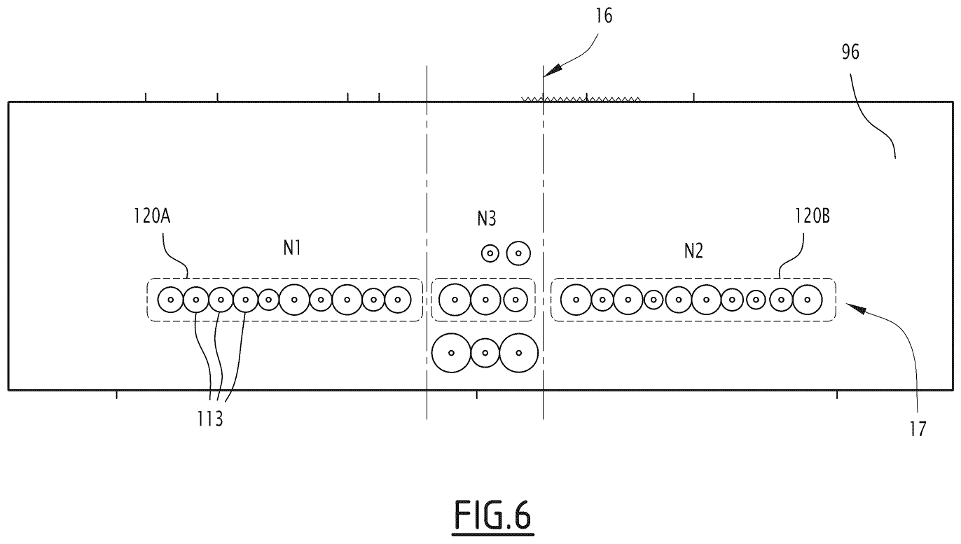

With reference to FIG. 6, once the axial alignment 16 and the transverse rows 17 have been determined by the identification modules 94, 98, the counting module 100 is configured to count the numbers N1, N2 of lights 113 on each transverse row 17 detected by the identification module 94, on either side of the axial alignment 16 determined by the identification module 98, as well as the number N3 of lights on the row 17 which form part of the axial alignment 16.

Thus, on each transverse row 17, the number N1 of lights 113 in a first lateral pack of lights 120A is counted on one side of the axial alignment 16, and the number N2 of lights 113 in a second lateral pack 120B of lights is counted on the other side of the axial alignment 16.

Also, on each transverse row 17, the number N3 of lights 113 in an axial pack of lights 122 is counted in the axial alignment 16.

From the number N1 of lights in the first side pack 120A, the number N3 of lights in the axial pack 122, and the number N2 of lights in the second side pack 120B, the counting module 100 is configured to define a transverse signature ST of the transverse row of lights 17 consisting, for example, of these three numbers [N1, N3, N2].

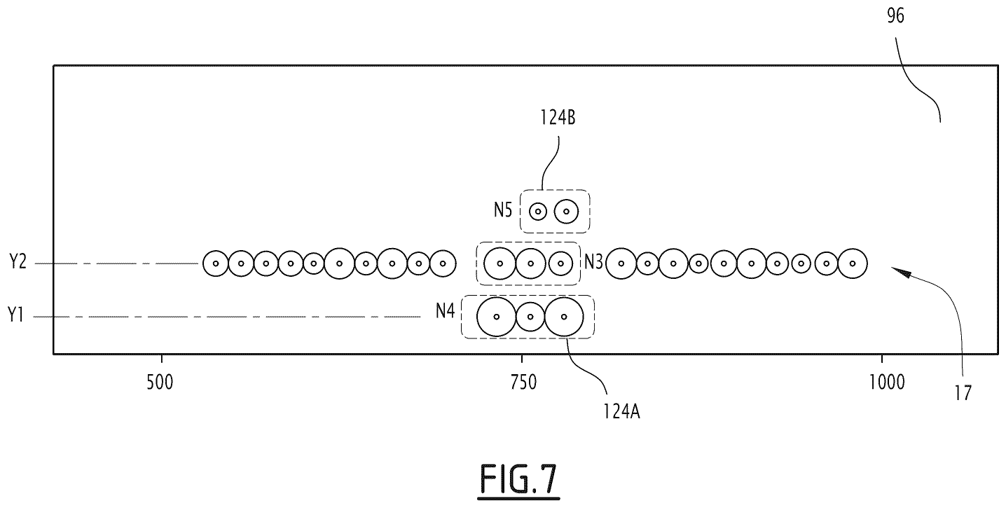

Similarly, as illustrated in FIG. 7, the counting module 100 is configured to determine the numbers N4, N5 of lights 113 on transverse rows of lights 17 located at the front and rear of the row of lights 17 respectively in an upstream pack 124A, and in a downstream pack 124B.

From the number N4 of lights 113 in the upstream pack 124A, the number N3 of lights 113 in the axial pack 122, and the number N5 of lights in the downstream pack 124B, the counting module 100 is configured to define an axial signature SA of the transverse row of lights 17 consisting of these three numbers [N4, N3, N5].

The signature base 104 contains known reference signatures STR, SAR corresponding to transverse rows 17 of lights found on various known types of approach lighting systems, and not necessarily to the runway 13 on which the aircraft 12 is intended to land.

Thus, in the example shown in FIG. 3, for a CALVERT lighting system described in this figure, the signature base 104 comprises a transverse reference signature STR, and an axial reference signature SAR corresponding to each transverse row 17A to 17E of the row of lights.

Advantageously, a plurality of reference signatures STR, SAR are associated with each transverse row 17A to 17E of the row of lights to take account in particular of any light failures or more generally of the failure of at least one light or even several lights on the transverse rows 17A to 17E to turn on.

Thus, in the example shown in FIG. 6, the row of lights 17 is associated with the normal signature [N1, N3, N2] when all the lights are operating, but also with the signatures [N1-1, N3, N2], [N1, N3-1, N2], [N1, N3, N2-1], [N1-1, N3-1, N2] etc., which are representative of the non-activation of one or more lights in the row of lights 17.

In this way, a catalogue of simple reference signatures STR, SAR is defined in the signature base 104, these reference signatures STR, SAR representing distinct and unambiguously identifiable row of lights configurations, each corresponding to a type of approach lighting system 15. These signatures are advantageously catalogued in the signature database 104 without having to identify the precise runway ahead of which the approach lighting system 15 is positioned.

This catalogue of signatures can be easily enhanced by simple rules that consume little memory space and computing resources, making the implementation and use of the signature database 104 compatible and robust with the on-board computers of an aircraft 12.

For a given type of approach lighting system 15, the position of the transverse rows 17A to 17E being known and possibly standardised in relation to a runway threshold, each pair of signatures STR, SAR in the signature base 104 is therefore associated with a distance from the runway threshold or with a limited number (generally at most two) of possible distances from the runway threshold. In the latter case, each distance from the transverse row 17A to 17E to the runway threshold corresponds to a given row-to-row distance between two adjacent transverse rows 17A to 17E.

Advantageously, as specified above, the signature base 104 does not necessarily establish a direct link between a pair of signatures STR, SAR and a distance to the runway threshold on each known runway 13, but simply a link between a pair of signatures STR, SAR and a distance to the runway threshold of a transverse row of one or more types of generic approach lighting systems 15.

Alternatively, when the color of the lights can also be determined, for example by a “red green blue” (RGB) detector or by weighing the radiometries of the various detectors in the sensor 32, a colorimetric signature SCR is advantageously associated with one or more lights in the row of lights, making it possible to refine and/or eliminate ambiguities between transverse rows 17 of the same lighting system 15 or of different types of lighting systems 15.

The comparison module 106 is able, on the basis of the signatures ST, SA identified from the transverse row of lights 17, to compare these signatures ST, SA with known signatures STR, SAR in the signature database 104, in order to identify a pair of known signatures STR, SAR corresponding to the signatures ST, SA detected in the signature database 104.

Advantageously, in order to positively associate the observed signatures ST, SA with the known signatures STR, SAR, the comparison module 106 is configured to check at different successive instants that the observed signatures ST, SA at the different successive instants do indeed correspond to the same known signatures STR, SAR over several of the different successive instants. This ensures temporal consistency in the detection of the reference signature STR, STA, which increases robustness.

If, in the database, the pair of signatures ST, SA is associated with a single distance from the threshold of the runway 13, the module 108 for calculating the geographical position of the row of lights with respect to the runway 13 uses the distance associated with the identified known signature STR, SAR (for example 300 metres) to determine the actual geographical distance between the row of lights 17 which has just been detected and identified and the threshold of the runway 13.

In one variant, at least two possible distances are associated with the pair of known signatures STR, STA in the signature base 104, for example because the transverse rows of adjacent lights 17 are potentially separated by either a first distance or a second distance (for example 30 metres or 60 metres).

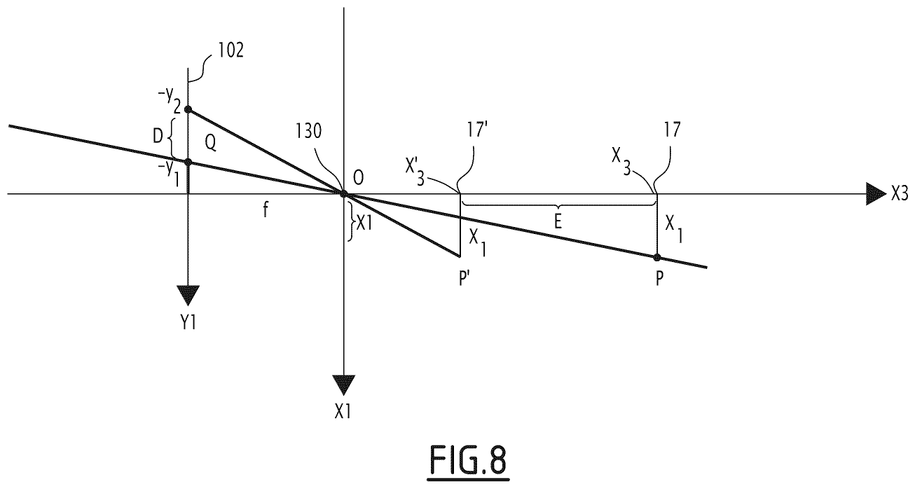

In this case, the module 108 for calculating the geographical position is configured to consider an assumed difference in actual distance along the axis A-A′ between the transverse row 17 under consideration and at least one light of a row adjacent to the transverse row 17 under consideration, from among at least two predetermined assumed differences, and then to calculate an assumed height of the aircraft with respect to the ground using the assumed distance, with the aid of an optical model of a needle head as shown in FIG. 8.

In this model, the electro-optical/infrared sensor 32 is positioned at point 130, at an altitude X1 which the calculation module 108 calculates.

To implement the calculation, the deviation E=X3−X3′ between the lights in the transverse row 17, and a light in the adjacent row 17′ is assumed to be equal to one of the assumed deviations.

Furthermore, the measured distance D=−Y1+Y2 between the transverse row 17, and a light of the adjacent row 17′ on the optical image 102 is also known and the focal length f between the lens located at point 130 and the plane of formation of the optical image 102 is also known. The calculation module 108 then uses a pinhole-type projective geometry model to calculate the height X1 of the aircraft 12 relative to the ground for each possible assumed deviation. The height X1 is compared with the height measured by the sensor system 30.

The assumed deviation giving the calculated altitude closest to the actual altitude of the aircraft 12 is then used to establish the actual position of the transverse row 17 in relation to the threshold 18 of runway 13.

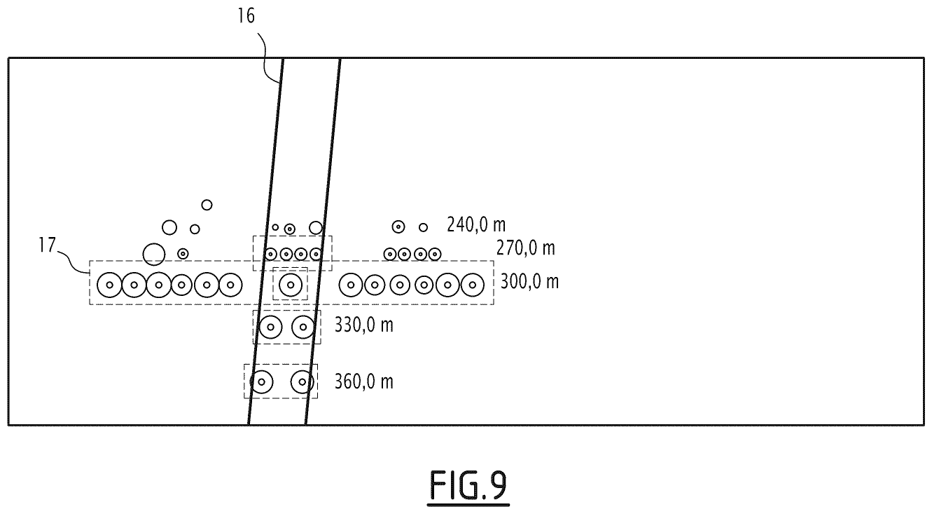

Once the distance to the runway threshold of the transverse row 17 has been calculated by the calculation module 108, it can be displayed on the display 36, as shown in FIG. 9.

Next, the calculation module 108 is configured to calculate the actual position on the display 36 at which the runway 13 should be, for example the actual position on the display 36 at which the threshold bar 18 should be, as a function of the actual position of the detected row of lights 17.

Then, the inconsistency warning module 112 is configured to generate a warning signal, when the difference between the position displayed on the display 36 of the synthetic depiction 41 of the runway 13 and the actual position on the display 36 of the runway 13 and/or of the approach lighting system 15 calculated by the calculation module 108 is greater than a given threshold, for example than a threshold defined in distance on the display, or in terms of number of pixels.

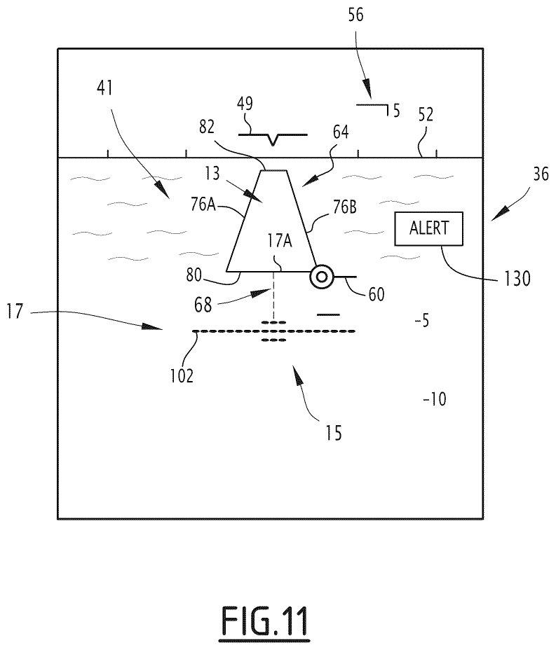

The warning signal is transmitted to the display generator 38, for example, to display a visual alert 130 on the display 36, as shown in FIG. 11. Alternatively, or additionally, the alert can be audible and/or tactile.

Furthermore, on receiving the warning signal, the display generator 36 is also configured to suppress the display of the synthetic depiction 41, or at least of the marking 64 of the runway 13.

The operation of the vision system 10 according to the present disclosure during the approach to a runway 13 will now be described, with reference to FIGS. 2 to 10.

Initially, the aircraft 12 descends towards the runway 13. As shown in FIG. 2, the generation module 50 generates the display of the horizon line 52. The generation module 54 generates the display of a pitch scale 56 and the generation module 58 generates the display of a speed vector symbol 60 whose vertical distance from the horizon line 52 translates the aircraft pitch, on the pitch scale 56.

At a given distance from the runway 13, the pilot selects the chosen runway 13. When the distance is less than a given display distance, for example 19.2 km (10 nautical miles) or/and a given display height, for example 600 m (2000 feet), the generation module 62 activates the display of the runway location marking 64. It queries the database 46 to determine the geographical locations of the lines 78A, 78B and transcribes this geographical position into a corresponding position on the display 36 to display the lateral lines 76A, 76B.

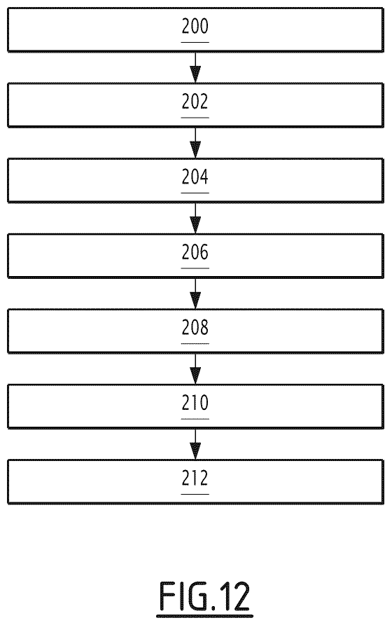

The inconsistency detection system 43 is also activated according to the steps illustrated in FIG. 12.

In step 200, the identification module 94, with reference to FIG. 5, receives at each instant, an optical image 96 of the space situated in front of the aircraft obtained by the electro-optical/infrared sensor 32, and processes this optical image 96 to obtain, in the optical image 96, a detection of the approach lights 113 observed in the approach lighting system 15, or in a threshold bar of the runway 13.

In step 202, the identification module 94 determines which of the approach lights 113 detected in the optical image 96 constitute transverse rows 17 of lights of an approach lighting system 15.

Similarly, the identification module 98 determines, from among the approach lights 113 detected in the optical image 96, axial alignments 16 extending along the axis A-A′ of the runway 13, or parallel thereto.

In step 204, with reference to FIG. 6, once the axial alignment 16 and the transverse rows 17 have been determined by the identification modules 94, 98, the counting module 100 counts the numbers N1, N2 of lights 113 on each transverse row 17 detected by the identification module 94, on either side of the axial alignment 16 determined by the identification module 98, as well as the number N3 of lights on the row 17 which form part of the axial alignment 16.

From the number N1 of lights in the first side pack 120A, the number N3 of lights in the axial pack 122, and the number N2 of lights in the second side pack 120B, the counting module 100 defines a transverse signature ST of the transverse row of lights 17 consisting, for example, of these three numbers [N1, N3, N2].

Similarly, as illustrated in FIG. 7, the counting module 100 determines the numbers N4, N5 of lights 113 on transverse rows of lights 17 located at the front and rear of the row of lights 17 respectively in an upstream pack 124A, and in a downstream pack 124B.

From the number N4 of lights 113 in the upstream pack 124A, the number N3 of lights 113 in the axial pack 122, and the number N5 of lights in the downstream pack 124B, the counting module 100 defines an axial signature SA of the transverse row of lights 17 consisting of these three numbers [N4, N3, N5].

In step 206, on the basis of the identified signatures ST, SA, the comparison module 106 compares these signatures ST, SA with known signatures STR, SAR in the signature database 104, and identifies a pair of known signatures STR, SAR corresponding to the signatures ST, SA detected in the signature database 104.

In step 208, if in the database, the pair of signatures ST, SA is associated with a single distance from the threshold of the runway 13, the module 108 for calculating the geographical position of the row of lights with respect to the runway 13 uses the distance associated with the identified known signature STR, SAR to determine the actual geographical distance between the row of lights 17 which has just been detected and identified and the threshold of the runway 13.

In one variant, if at least two possible distances are associated with the pair of known signatures STR, STA in the signature base 104, the module 108 for calculating the geographical position considers an assumed difference in actual distance along the axis A-A′ between the transverse row under consideration and at least one light of a row adjacent to the transverse row 17 under consideration, from among at least two predetermined assumed differences, and then calculates an assumed height of the aircraft 12 with respect to the ground using the assumed distance, with the aid of an optical model of a needle head as described above.

The assumed deviation giving the calculated altitude closest to the actual altitude of the aircraft 12 is then used to establish the actual position of the transverse row 17 in relation to the threshold 18 of runway 13.

Next, in step 210, the calculation module 108 calculates the actual position on the display 36 at which the runway 13 should be, for example the actual position on the display 36 at which the threshold bar 18 should be, as a function of the actual position of the detected row of lights 17.

Then, in step 212, the inconsistency warning module 112 is configured to generate a warning signal, when the difference between the position displayed on the display 36 of the synthetic depiction 41 of the runway 13 and the actual position on the display 36 of the runway 13 and/or of the approach lighting system 15 calculated by the calculation module 108 is greater than a given threshold, for example than a threshold defined in distance on the display 36, or in terms of number of pixels.

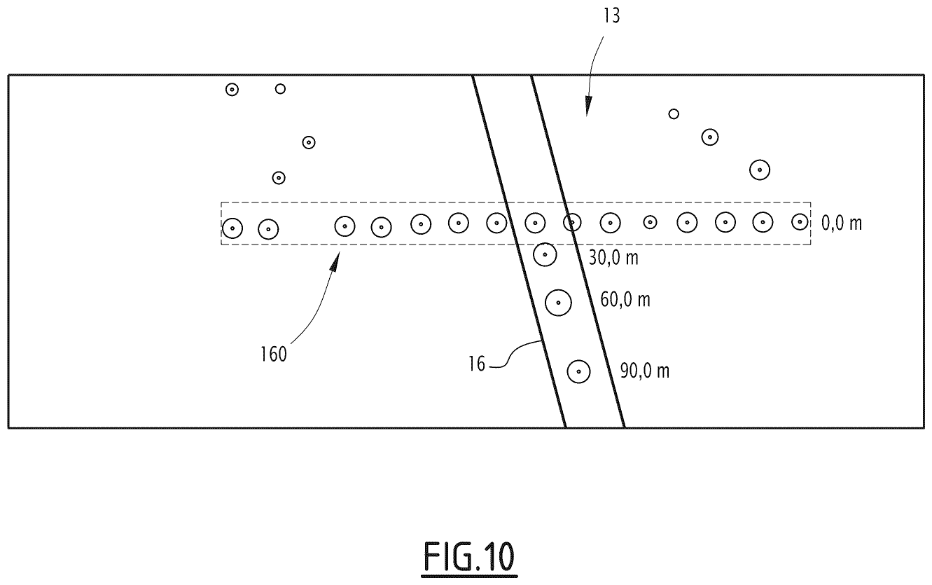

In a variant illustrated in FIG. 10, the inconsistency detection system 43 also comprises a threshold bar signature database 160, the counting module 100 being configured to determine the number of lights on the threshold bar 160, and in the axial alignment 16, at least one side of the threshold bar 160.

Thus, the comparison module 106 is configured to detect the position of the threshold bar 160, and the calculation module 108 is configured to compare the actual position of the threshold bar on the display 36 using the calculated position of the threshold bar 160.

Advantageously, the comparison module 106 is configured to determine whether the threshold bar 160 is a runway threshold bar or a threshold bar offset in front of the runway threshold, for example as a function of the number of lights present in the threshold bar 160, the transverse signature of the threshold bar or the color of the lights detected on the threshold bar.

For example, if the number of lights detected on a transverse row of lights 17 is greater than a given value, for example greater than 20, the comparison module 106 is configured to determine that this is indeed a threshold bar 160 and not a transverse row 17 of lights of the lighting system 15.

In addition, if the signature comprises lights of a specific color, for example red lights, the comparison module 106 is configured to discriminate between a runway threshold bar and an offset threshold bar.

For example, the 106 comparison module determines a transverse row and a red light, it identifies an end of runway or a shifted threshold. On the other hand, if it detects a transverse row and a green light, it identifies a runway threshold. If it detects a transverse row and a white light, it identifies an approach lighting system.

The inconsistency warning module 112 is then configured to detect an inconsistency between the displayed position of the synthetic depiction 41 and the actual position on the display 36 of the threshold bar 160.

In another variant, the calculation module 108 is configured to calculate a roll angle of the aircraft 12, on the basis of a detected axial orientation of the alignment 16 detected by the identification module 98.

In one embodiment, the display 36 does not necessarily display the image 102 on the display 36. Nevertheless, the image 102 is processed by the inconsistency detection system 43 to detect an inconsistency in the positioning of the synthetic depiction 41, as described previously.

In one variant, the light counting module 100 comprises an artificial intelligence engine configured to determine, from a region of the optical image 96 including the transverse row of lights 17 without including all the rows of lights of the approach lighting system 15, a corrected signature SA, ST of the rows of lights to take account in particular of any light failures or more generally the non-activation of at least one light, or even of several lights of the transverse row of lights 17.

The artificial intelligence engine receives as input data at least the numbers N1, N2 of lights 113 on each transverse row 17 detected by the identification module 94, on either side of the axial alignment 16 determined by the identification module 98, as well as the number N3 of lights on the row 17 which form part of the axial alignment 16, as well as the region of the optical image. The output of the artificial intelligence engine is the corrected signature(s) SA, ST.

It comprises, for example, a neural network advantageously comprising:
convolutional layers with different pooling and encoding stages,
at least one projection stage that concatenates the data with the input data; and/or
fully connected layers, preferably of the perceptron type, to produce the expected outputs.

The artificial intelligence engine is trained by providing it, as training data, with a plurality of images representative of regions located around transverse rows of lights 17 of various approach lighting structures 15, with possible light failures or, more generally, non-activations of at least one light, and by providing it, as a match for each image, with the configuration of the number of lights detected, and the corrected signature(s) corresponding to the transverse row of lights 17 on each image.

In another variant, the system for characterising the transverse row of lights 17 identified from the first identification module 94 has no counting module 100. It comprises, as a replacement for the counting module 100, an artificial intelligence engine configured to determine the determined position of the row of lights with respect to the runway 13 from among the plurality of possible positions of rows of lights extending transversely to an axis A-A′ of the runway 13.

The artificial intelligence engine is configured to determine the position of the row of lights and possibly the type of approach lighting system 15 to which the row of lights 17 belongs, from an analysis of a region of the optical image 96 comprising the transverse row of lights 17, without including all the transverse rows of lights at all the positions among the plurality of possible positions.

The artificial intelligence engine receives as input data the region of the optical image 96 containing the transverse row of lights 17, without necessarily containing all the transverse rows of lights of the approach lighting system 15. It produces as output data the position of the transverse row of lights 17 relative to the runway 13 and/or the type of approach lighting system 15 to which the transverse row of lights 17 belongs.

For example, it comprises a convolutional neural network, as described above.

The artificial intelligence engine is trained by providing it, as training data, with a plurality of images representative of regions located around transverse rows of lights of various approach lighting structures 15, with possible light failures or, more generally, with the non-activation of at least one light, and by providing it, in a corresponding manner for each image, with the position of the transverse row lights, and optionally with the type of approach lighting system 15 to which the transverse row of lights belongs.

What is claimed is:

1. An aircraft enhanced vision system comprising:
a display configured to view a space in front of an aircraft, and a display generator on the display configured to display on the display a synthetic depiction of a positioning of a landing runway and/or of an approach lighting system towards the runway, at a displayed position of the runway and/or of the approach lighting system; and
an inconsistencies detector configured to detect inconsistencies between the displayed position from the synthetic depiction and an actual viewing position on the display of the runway and/or of the approach lighting system,
the inconsistencies detector being configured to:
identify, in an optical image of the space in front of the aircraft, at least one row of lights extending transversely to an axis of the runway;
characterize the identified at least one row of lights and determine a determined position of the row of lights relative to the runway from among a plurality of possible positions of rows of lights extending transversely to an axis of the runway, and
calculate the actual viewing position on the display of the runway and/or of the approach lighting system using the determined position of the identified at least one row of lights.

2. The system according to claim 1, wherein the inconsistencies detector is configured to characterize the identified at least one row of lights by light counting on the row of lights to define at least one signature of the row of lights; and by comparing the at least one signature of the row of lights with known signatures of rows of lights in a database of known signatures of rows of lights, to identify at least one known signature corresponding to the at least one signature defined by light counting, the inconsistencies detector is configured to characterize the identified at least one row of lights by determining a determined position of the at least one row of lights using the or each known signature identified by comparing the at least one signature of the row of lights with known signatures of rows of lights in a database of known signatures of rows of lights.

3. The system according to claim 2, wherein the light counting is configured to define at least one transverse signature of the at least one row of lights.

4. The system according to claim 3, wherein the inconsistencies detector is configured to identify, in the optical image, an alignment of lights extending along the axis of the runway, the light counting being configured to count, on the at least one row of lights, a number of lights on either side of the alignment and, in the alignment, to define at least one signature of the at least one row of lights.

5. The system according to claim 4, wherein the transverse signature comprises a number of lights on the alignment in the at least one row of lights, and numbers of lights detected on either side of the alignment in the at least one row of lights.

6. The system according to claim 4, wherein the light counting is configured to define at least one axial signature of the at least one row of lights.

7. The system according to claim 6, wherein the axial signature comprises a number of lights on the alignment at the at least one row of lights and at least one number of lights on at least one row of lights axially adjacent to the at least one row of lights.

8. The system according to claim 4, wherein the inconsistencies detector is configured to calculate a roll angle of the aircraft, based on a determined axial orientation of the alignment extending along the axis of the runway.

9. The system according to claim 2, wherein the inconsistencies detector is configured to identify a color and/or a periodic lighting intermittence of at least one light in the at least one row of lights, the signature of the at least one row of lights comprising at least the color and/or a lighting intermittence feature of at least one light in the at least one row of lights.

10. The system according to claim 2, wherein the at least one row of lights is a transverse row of the approach lighting system to the runway, the database being a database of signatures of transverse rows of approach lighting systems to a runway.

11. The system according to claim 2, wherein the at least one row of lights is a runway threshold bar, the database being a database of runway threshold bar signatures.

12. The system according to claim 10, wherein the at least one row of lights is a runway threshold bar, the database being a database of runway threshold bar signatures, the inconsistencies detector being configured to determine from the signature of the at least one row of lights whether the at least one row of lights is a transverse row of the approach lighting system to the runway or whether the at least one row of lights is a runway threshold bar.

13. The system according to claim 1, wherein the inconsistencies detector comprises an artificial intelligence engine configured to determine the determined position of the at least one row of lights with respect to the runway from among the plurality of possible positions of rows of lights extending transversely to an axis of the runway from an analysis of a region of the optical image comprising the at least one row of lights.

14. The system according to claim 1, wherein the inconsistencies detector is configured to determine an actual distance between the at least one row of lights and at least one light adjacent to the at least one row of lights using the distance on the optical image between the at least one row of lights and the adjacent light, and a measured height of the aircraft relative to the ground.

15. The system according to claim 14, wherein the inconsistencies detector is configured to assume a predetermined actual distance gap between the light adjacent to the at least one row of lights and the at least one row of lights, and then is configured to calculate an assumed height of the aircraft relative to the ground, using the assumed distance between the lights, and to compare the assumed height of the aircraft relative to the ground with the measured height of the aircraft relative to the ground.

16. The system according to claim 1, wherein the inconsistencies detector is configured to generate a warning signal when the difference between the position displayed on the display of the synthetic depiction and the actual viewing position on the display of the runway and/or of the approach lighting system calculated by the inconsistencies detector is greater than a given threshold.

17. An enhanced vision method implemented in an aircraft equipped with the enhanced vision system according to claim 1, the method comprising:
displaying on the display via the display generator, a synthetic depiction of the positioning of a runway and/or of an approach lighting system towards the runway at a displayed position of the runway and/or of the approach lighting system;
detecting, via the inconsistencies detector, an inconsistency between the displayed position from the synthetic depiction and the actual viewing position on the display of the runway and/or of the approach lighting system;
detecting the inconsistency between the displayed position from the synthetic depiction and the actual viewing position on the display of the runway and/or of the approach lighting system comprising:
identifying, via the inconsistencies detector, in an optical image of the space in front of the aircraft, at least one row of lights extending transversely to an axis of the runway;
characterizing, via the inconsistencies detector, the identified at least one row of lights, to determine a determined position of the at least one row of lights relative to the runway from among a plurality of possible positions of rows of lights extending transversely to an axis of the runway,
determining, via the inconsistencies detector, an actual position on the display of the runway and/or of the approach lighting system using the determined position of the at least one row of lights.

18. The method according to claim 17, wherein characterizing, via the inconsistencies detector, the identified at least one row of lights comprises counting lights on the at least one row of lights, via the inconsistencies detector, to define at least one signature of the at least one row of lights and comparing, via the inconsistencies detector, the at least one signature of the at least one row of lights with known signatures of rows of lights in a database of known signatures of rows of lights, to identify at least one known signature corresponding to the at least one signature defined by the light counting; the method comprising determining, via the inconsistencies detector, a determined position of the at least one row of lights using the identified at least one known signature.
